(19) United States
(12) Patent Application Publication
(10) Pub. No.: US 2011/0195333 A1
(43) Pub. Date: Aug. 11, 2011

(54) FUEL CELL STACK INCLUDING INTERNAL REFORMING AND ELECTROCHEMICALLY ACTIVE SEGEMENTS CONNECTED IN SERIES

(75) Inventors: Aaron T. Crumm, Ann Arbor, MI (US); Timothy LaBreche, Ann Arbor, MI (US)

(73) Assignee: ADAPTIVE MATERIALS, INC., Ann Arbor, MI (US)

(21) Appl. No.: 12/701,758

(22) Filed: Feb. 8, 2010

(51) Int. Cl. H01M 8/24

(52) U.S. Cl. 429/466; 429/452

(57) ABSTRACT

A solid oxide fuel cell stack includes a solid oxide fuel cell tube and a reformer inside the tube. The tube includes a plurality of electrochemical cells electrically connected in series. Each electrochemical cell includes an electrolyte disposed between an interior anode and an exterior cathode. The fuel reformer is configured to convert a hydrocarbon fuel to a fuel cell fuel comprising hydrogen such that hydrogen is provided to an anode of the solid oxide fuel tube.

### FIELD OF THE INVENTION

The present disclosure is related to a fuel cell stack having internal reforming fuel cell tubes with multiple electrochemically active segments interconnected in series.

### BACKGROUND

The statements in this section merely provide background information related to the present disclosure and may not constitute prior art. Fuel cells have been developed for portable power applications to compete with portable generators, batteries, and other energy conversion devices. Fuel cells are advantageous over generators in that fuel cells can operate at higher fuel-to-energy conversion efficiency levels. In particular, a generator's efficiency is limited by an efficiency ceiling defined by the generator's Carnot cycle. Because fuel cells convert a fuel's chemical energy directly to electrical energy, fuel cells can operate at efficiency levels that are much higher than generators at comparable power levels.

Portable fuel cell modules can meet power and energy requirements that are not met by either batteries or other energy conversion devices. For example, high-efficient lithium ion batteries can have more than ten times the weight-to-energy ratio as an energy equivalent fuel cell module inclusive of three days of fuel.

Improvements in performance and cost reduction will enable the large-scale adoption of fuel cells in the commercial marketplace. Areas for fuel cell performance improvement include fuel cell module weight improvements, fuel cell fuel efficiency improvements, and fuel cell durability improvements. Areas of cost improvements include reducing material costs, improving high volume manufacturing efficiency, decreasing fuel consumption, and decreasing operating costs.

The following description and figures sets forth a fuel cell module having improvements in performance and cost, which will progress adoption of fuel cell modules in the commercial applications.

### SUMMARY

A solid oxide fuel cell stack includes a solid oxide fuel cell tube and a reformer inside the tube. The tube includes a plurality of electrochemical cells electrically connected in series. Each electrochemical cell includes an electrolyte disposed between an interior anode and an exterior cathode. The fuel reformer is configured to convert a hydrocarbon fuel to a fuel cell fuel comprising hydrogen such that hydrogen is provided to an anode of the solid oxide fuel tube.

### BRIEF DESCRIPTION OF THE DRAWINGS

FIG. 1A depicts a prospective view of a fuel cell module in accordance with an exemplary embodiment of the present disclosure;

FIG. 1B depicts an exploded prospective view of the fuel cell module of FIG. 1A;

FIG. 1C depicts a prospective view of the fuel cell stack and a top view of an electrical connector portion of the fuel cell module of FIG. 1A;

FIG. 2 depicts a cross-sectional view of the fuel cell module of FIG. 1A;

FIG. 3A depicts a cross-sectional view of a fuel cell tube and a feed tube of the fuel cell module of FIG. 1A;

FIG. 3B depicts a cross-sectional view of a fuel cell tube of a fuel cell module in accordance with another exemplary embodiment of the present disclosure;

FIG. 3C depicts a cross-sectional view of the fuel cell tube of FIG. 3B and the fuel feed tube of the fuel cell module of FIG. 1A; and

FIG. 4 depicts a cross-sectional view of a fuel cell module in accordance with another exemplary embodiment of the present disclosure; and

FIG. 5A and FIG. 5B depicts cross sectionals representing various manufacturing stages for manufacturing the fuel cell tube of FIG. 3A.

It should be understood that the appended drawings are not necessarily to scale, presenting a somewhat simplified representation of various preferred features illustrative of the basic principles of the invention. The specific design features of the electric power generation device will be determined in part by the particular intended application and use environment. Certain features of the illustrated embodiments have been enlarged or distorted relative to others for visualization and clear understanding. In particular, thin features may be thickened, for example, for clarity of illustration. All references to direction and position, unless otherwise indicated, refer to the orientation of the fuel cell module illustrated in the drawings.

### DETAILED DESCRIPTION OF THE EMBODIMENTS

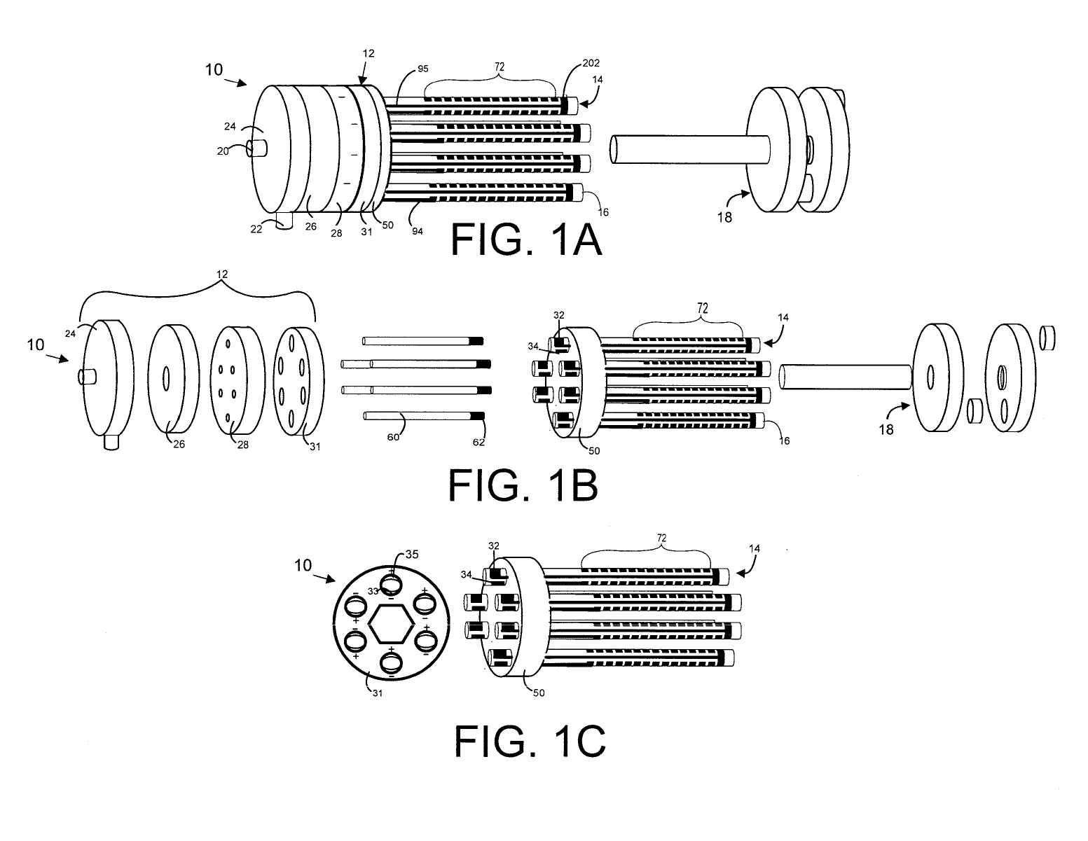

Referring to the figures, wherein exemplary embodiments are described and wherein like elements are numbered alike, FIG. 1 depicts a fuel cell module 10. The fuel cell module 10 comprises a plurality of fuel cell tubes (each of which will be described in reference to fuel cell tube 16), wherein the fuel cell tube 16 has multiple active areas and wherein the fuel cell module 10 is configured to reform propane or another hydrocarbon such as butane, gasoline, diesel fuel, kerosene, or combinations thereof within the fuel cell tubes 16.

By segmenting the active areas of each fuel cell tube and connecting each active area in series, voltage generated by each tube increases proportionally to the number of segments and current generated by each tube decreases proportionally to the number of segments when compared to a fuel cell tube having a similarly-sized, unsegmented active area. For example, when compared to a fuel cell tube having a similarly-sized, unsegmented active area, a fuel cell tube having ten segments connected in series nominally generates approximately ten times the voltage, approximately one tenth the current, and an approximately equivalent amount of power. As used herein, the terms “active area,” refer to an area of the tube comprising an anode and cathode, reacting anode reactants and cathode reactants, respectively, and an ion conducting electrolyte. Further, as used herein the term “tube” refers to any structure generally configured to direct fluid. Although the exemplary fuel cell tube comprises a continuously enclosed circular cross-section, in an alternate embodiment, alternate geometries can be utilized and the cross-section does not have to be fully enclosed. Exemplary alternate geometries include polygonal shapes, for example rectangular shapes, and other ovular shapes.

Although the fuel cell tube having segmented active areas generates approximately equal levels of power to the fuel cell tube having a similarly-sized, unsegmented active area, decreasing a quantity of electrical current transported through each fuel cell tube and through the fuel cell module facilitates several advantageous design characteristics.

For example, decreasing electrical current facilitates utilizing less current conduction capacity to route current from the fuel cell tubes while maintaining equivalent levels of power transfer from the fuel cell tubes. Therefore, by generating less electrical current, fuel cell tubes having segmented active areas connected in series can utilize a less conductive current collection and conduction system for routing electricity away from fuel cell tubes than fuel cell tubes having a similarly-sized, unsegmented active area. “Less conductive current collection and conduction system” as used above, can include a current collection and conduction system with lower amounts of current collecting and conducting material and a current collection and conduction system comprising material with higher resistivity values.

Thus, power can be efficiently transferred from an anode of the fuel cell tubes having segmented active areas connected in series with a current collector that is sized much smaller than a current collector of an unsegmented fuel cell tube generating equivalent amounts of power. In one embodiment, the electrodes of the fuel cell tubes having segmented active areas connected in series comprise a sufficient current conduction capacity to route electrical current from the fuel cell tubes without utilizing a current collector disposed within the inner circumference of the fuel cell tube.

Internal reforming within the fuel cell tube provides highly efficient fuel conversion, due to heat transfer between the internal reformer and the fuel cell tube. Fuel cells tubes utilizing unsegmented active areas include internal current collectors and anodes exposed at the inner circumference of the tube. These current collectors can obstruct air and fuel flow, thereby decreasing reforming efficiency. Further, if a substantial amount of unreformed hydrocarbon fuel such as propane, butane, gasoline, kerosene, and diesel fuel contacts metals such as nickel utilized for fuel cell anodes and fuel cell current collectors, the unreformed hydrocarbon can degrade fuel cell anode or the internal current collector. Providing a segmented fuel cell with an internal reformer allows a fuel cell to operate utilizing internal reforming while minimizing or eliminating interactions between unreformed fuel and the fuel cell anode and internal current collectors.

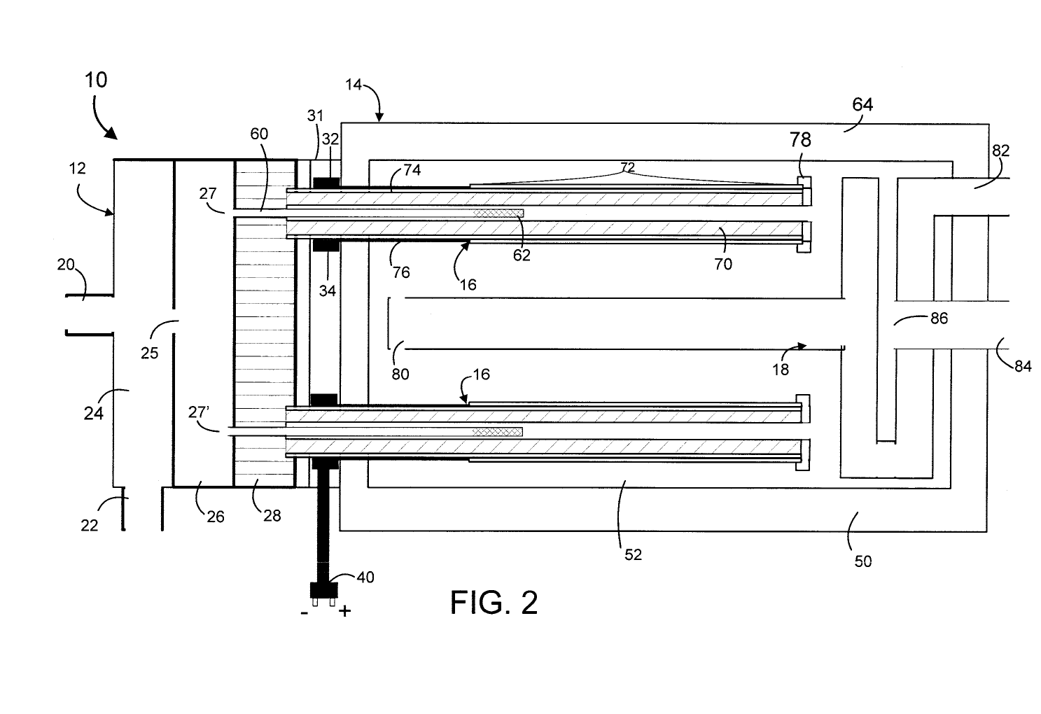

Referring to FIGS. 1A, 1B, 1C, and 2, the fuel cell module 10 includes a manifold 12, a fuel cell stack 14 and a heat recuperator 18. The fuel cell module 10 is part of a fuel cell system that further includes balance of plant components including pumps (not shown) and various other actuators, valves, sensors, electrical transfer components, and control components not depicted in the figures. The exemplary fuel cell module 10 is a part of a portable fuel cell system configured for human or vehicle transport. However, features of the exemplary fuel cell modules described herein are also applicable to stationary fuel cell systems.

The manifold 12 comprises a mixing portion 24, a distribution portion 26, a base portion 28, and an electrical connector portion 31. The manifold 12 receives air through the air inlet 22 and raw fuel through the fuel inlet 20.

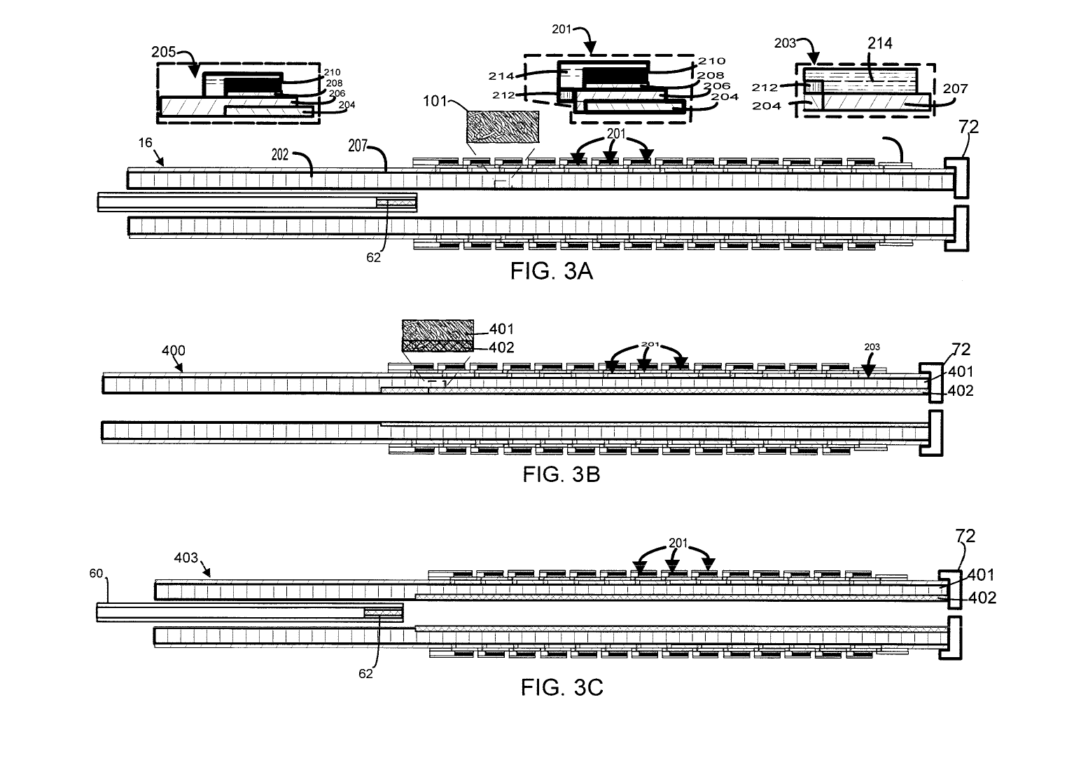

The heat recuperator 18 is provided to transfer heat between fuel cell exhaust and incoming cathode air to the insulated chamber 52. In an alternate embodiment, the heat recuperator can preheat incoming fuel in addition to heating incoming cathode air. The cathode air is routed to cathode portions 210 (FIG. 3A) of the fuel cell tubes 16 and is utilized as an electrochemical reactant for reactions at the cathode of the fuel cell tubes 16. The heat recuperator 18 includes an air inlet 82, an air outlet 80, an exhaust inlet 86, and an exhaust outlet 84.

The fuel cell stack 14 includes an insulative body 50 defining an insulative chamber 52, the plurality of fuel cell tubes (each of which are generally referred to as fuel cell tube 16), a plurality of fuel feed tubes (each of which are generally referred to as fuel feed tube 60), and a cap member 78.

The fuel cell tubes 16 include a cathode lead 94 and an anode lead 95, which are connected to terminals 35, 33 of the electrical connection portion 31. In an exemplary embodiment, the cathode lead 94 and the anode lead 95 each comprise silver palladium and are deposited on the fuel cell tube 16 by screen printing. The electrical connector portion 31 includes internal wires to electrically interconnect the fuel cell tubes 16 in series or parallel connection, and to route electricity an external power connector (not shown).

The fuel feed tube 60 extends from the distribution chamber 26 into the insulation chamber 52. The fuel feed tube 60 is disposed in a fuel cell tube 16, wherein the fuel cell tube 16 extends from the base portion 28 into the insulated chamlber 52. The insulative body 50 can comprise high-temperature, ceramic-based material, for example, foam, aero-gel, mat-materials, and fibers formed from, for example, alumina, silica, and like materials.

The fuel feed tube 60 comprises a dense ceramic material compatible with the high operating temperatures within the insulated chamber 52, for example, an alumina based material or a zirconia based material.

Referring to FIG. 3A in an exemplary embodiment, the reformer 62 comprises a supported metallic catalyst material comprising a metal alloy comprising at least one of platinum, palladium, rhodium, iridium, osmium, and the like disposed on a ceramic substrate such as an alumina substrate or a zirconia substrate, wherein the ceramic substrate is disposed within the fuel feed tube 60. In particular, the reformer 62 can be substantially similar to that described in further detail in U.S. Pat. No. 7,547,484 entitled “Solid Oxide Fuel Cell Tube With Internal Fuel Processing”, the entire contents of which is hereby incorporated by reference herein. Fuel can be routed through the reformer 62 such that substantially no unreformed fuel contacts an anode portion 204 of the fuel cell tube 16.

Referring to FIG. 3B, in an alternate embodiment a fuel cell 400 includes a reformer 402 comprising a metallic catalyst is disposed directly on a support portion 401 of the fuel cell tube 16 such that fuel is substantially reformed by the fuel reformer 402 before the fuel contacts the anode portion 204. In an alternate embodiment, the reformer 402 can include a metallic catalyst disposed on a secondary support such as an aluminate material disposed on the support portion 401. In another alternate embodiment, the fuel

Referring to FIG. 3C, in another embodiment, a fuel cell tube 403 includes both the fuel feed tube 60 and the reformer 62 disposed within the fuel feed tube 60 and the reformer 402 comprising the supported metallic catalyst disposed directly on the supported portion 401 of the fuel cell tube 16. The amount of catalysts and the type of catalysts on each of the reformer 62 and the reformer 302 can be determined to provide desired reforming efficiency and desired heat transfer within the fuel cell tube 16.

Referring to FIG. 3A, the fuel cell tube 16 includes a support portion 70, a gas and electron barrier portion 207, and a plurality of cells units 201. Each cell unit 201 includes an anode portion 204, an electrolyte portion 206, an intermediate portion 208, a cathode portion 210, an interconnect portion 212, and a current collector portion 214. Collectively for each fuel cell tube 16, the anode portions 204 are referred to as “anode” herein, the electrolyte portions 206 are referred to as “electrolyte” herein and the cathode portions 210 are referred to as “cathode” herein. The support portion 202 can be formed through extrusion processes, pressing processes, casting processes, and like processes for forming ceramic members. In alternate embodiment, the fuel cell tube 16 can comprise a cathode without an intermediate portion, for example, a cathode comprising lanthanum strontium manganite (LSM).

For an exemplary thermoplastic extrusion processes see U.S. Pat. No. 6,749,799 to Crumm et al, entitled METHOD FOR PREPARATION OF SOLID STATE ELECTROCHEMICAL DEVICE, the entire contents of which is hereby incorporated by reference, herein.

In an exemplary thermoplastic ceramic extrusion process for forming support portion 70, a compound is prepared from 85.9 weight percent of 8 mole % yttria stabilized zirconia powder, 7.2 weight percent of polyethylene polymer, 5.3 weight percent of acrylate polymer, 1.0 weight percent of stearic acid, and 0.3 weight percent of heavy mineral oil, 0.3 weight percent of polyethylene glycol of a molecular weight of 1000 grams per mole. The microstructure and porosity of the support portion 202 can be tailored for desired gas diffusion rates and for chemical and thermomechanical compatibility with other portions of the fuel cell tube 16 including the electrolyte portion 206 and the electron barrier portion 207. The exact microstructure and porosity of the support portion 202 can be controlled in several ways, including through modifying the sintering temperature, modifying particle size distribution of the ceramic powder, engineering microstructure by extruding channels, and by the using pore-forming additives, such as carbon particles or similar pore-formers.

The anode portion 204 comprises an electrically and ionically conductive cermet that is chemically stable in a reducing environment. In an exemplary embodiment, the anode portion 204 comprises a conductive metal such as nickel, disposed in a ceramic skeleton, such as yttria-stabilized zirconia.

Exemplary materials for the electrolyte portion 206 and electron barrier portion 207 include lanthanum-based materials, zirconium-based materials and cerium-based materials such as lanthanum strontium gallium manganite, yttria-stabilized zirconia and gadolinium doped ceria, and can further include various other dopants and modifiers to affect ion conducting properties. The anode portion 204 and the cathode 210, which form phase boundaries (gas/electrolyte/electrode particle; commonly known as triple points) with the electrolyte portion 206 and are disposed on opposite sides of the electrolyte portion 206 with respect to each other.

The electrolyte portion 206 is disposed both on a surface of the anode portion 204 parallel to the anode portion 204 and abutting the anode portion 204. The section of the electrolyte portion 206 parallel to the anode portion provides an ion conduction pathway and electron insulation between the anode portion 204 and the cathode portion 210. The section of the electrolyte 204 abutting the anode portion 204 provides electron insulation between anode portions of separate cell units 201.

In general, the anode portion 204 and cathode portion 210 are formed of porous materials capable of functioning as an electrical conductor and capable of facilitating the appropriate reactions. The porosity of these materials allows dual directional flow of gases (e.g., to admit the fuel or oxidant gases and permit exit of the byproduct gases).

The cathode comprises an ionic and electrically conductive material chemically stable in an oxidizing environment. In an exemplary embodiment, the cathode comprises a perovskite material and specifically lanthanum strontium cobalt ferrite (LSCF). In an exemplary embodiment, each of the anode, electrolyte, and cathode are disposed within a range, of about 5-50 micrometers. An intermediate layer 208 may be disposed between the cathode portion 210 and the electrolyte portion 206 to decrease chemical reactivity between material in the cathode portion 210 and material in the electrolyte portion 206. In an exemplary embodiment, the intermediate portion 208 comprises strontium-doped cobaltate (SDC), and is disposed at a thickness within the range of 1-8 micrometers.

The interconnection portion 212 electrically connects an anode 204 of a cell unit to a cathode of a separate cell unit such that electrons can be conducted in series between the cell units. In an exemplary embodiment the interconnection portion comprises platinum. The current collector portion 214 conducts electrons across the cathode portion 210. In an exemplary embodiment, the current collector portion comprises a silver palladium alloy. In an alternate embodiment, the cathode current collector portion 214 can comprise an alloy comprising at least one of silver, palladium, and gold.

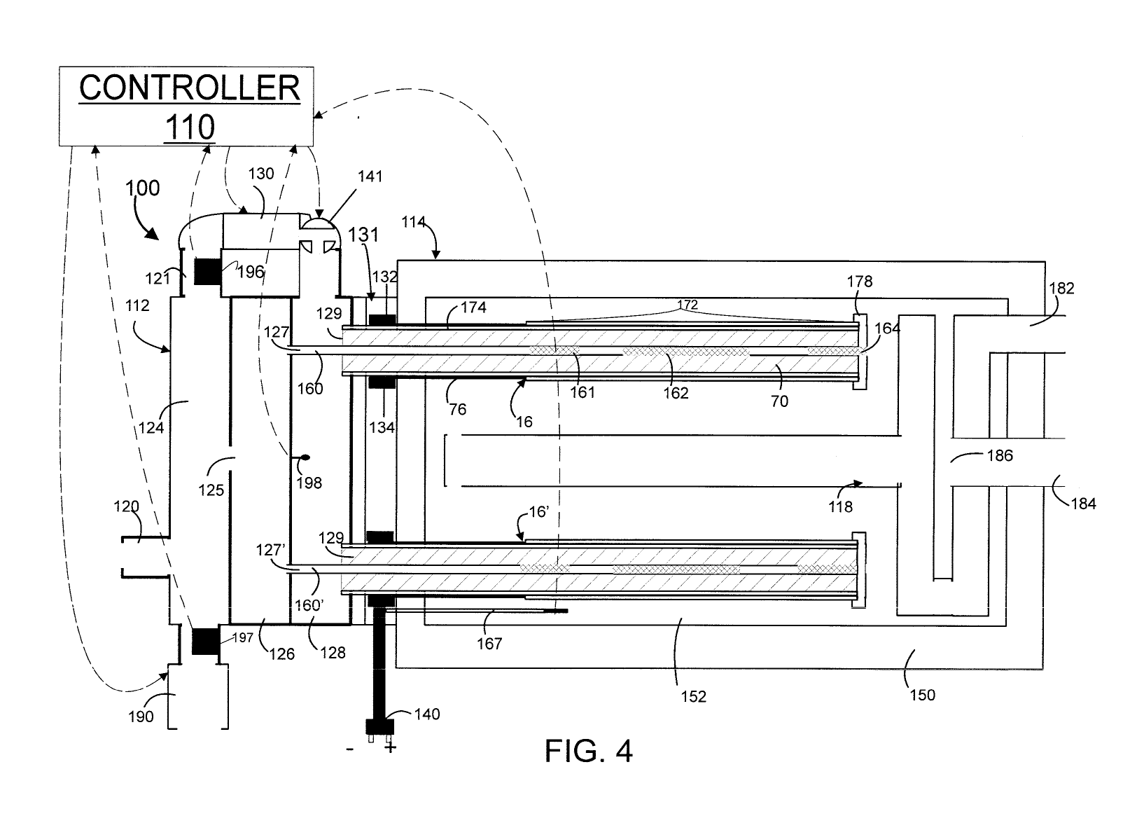

Referring to FIG. 4, a solid oxide fuel cell module 100 configured to operate utilizing partial oxidative reforming and at least one of onboard autothermal reforming and onboard steam reforming is shown. The fuel cell module 100 is configured to operate in at least one of autothermal reforming mode and steam reforming mode without requiring an onboard water storage tank. However, in alternate embodiments, an onboard water storage tank may be utilized to supplement or assist in the autothermal and steam reforming processes. The exemplary portable fuel cells can recycle water produced from the fuel cell reactions for onboard reforming.

The fuel cell module 100 includes a manifold 112, a fuel cell stack 114 and a controller 110. The fuel cell module 100 further includes balance of plant components including a cathode air pump, (not shown) and various other actuators, valves, sensors, electrical transfer components, and control components not depicted in the figures. The exemplary fuel cell module 100 is a portable fuel cell module configured for human or vehicle transport. However, features of exemplary fuel cell module described herein are also applicable to stationary fuel cell modules.

The manifold 112 comprises a mixing portion 124, a distribution portion 126, a water collection portion 128, a conduit 121, an electrical connector portion 131, recycled water flow sensor 196, recycled water diverter valve 141, anode air flow sensor 197, a humidity sensor 198, an anode air pump 190, and a water pump 130. The manifold 112 receives air through an air inlet 122 and raw fuel through the fuel inlet 120. Water enters the water collection chamber 128 of the manifold 112 through the water inlet 129 to recycle chamber 128. Water concentration within the collection chamber 128 can be measured utilizing the humidity sensor 198. In alternate embodiment, water from an external water source can be introduced to the mixing chamber 112 through the fuel inlet 120 or through a second water inlet (not shown).

The fuel cell stack 114 includes an insulative body 150 defining an insulative chamber 152, a plurality of fuel cell tubes (each of which are generally referred to as fuel cell tube 116), a plurality of fuel feed tubes (each of which are generally referred to as fuel feed tube 160), a heat recuperator 118, a cap member 178, and a thermocouple 167. The fuel cell stack 114 further includes a partial oxidation reformer 161 and a water-based reformer 162, each of which are disposed within each fuel feed tube 160, and a hydrogen separation membrane 164 extending out of each fuel feed tube 160. In an alternate embodiment, the hydrogen separation 164 member is integrated into the fuel feed tube 160, wherein a porous portion of the fuel feed tube is coated with hydrogen separation material (e.g., a palladium membrane) to provide hydrogen separation functionality.

The partial oxidation reformer 161 comprises a catalytic material composition and microstructure configured partial oxidation reforming, and the water-based reformer comprises a catalytic material composition and microstructure configured for autothermal and steam reforming. However, water-based reforming reactions may occur at the partial oxidation reformer 161 and partial oxidation reforming reaction may occur at the water-based reformer 162. Further, although fuel cell stack 114 includes two separate reformers comprising catalytic material optimized for specific reforming processes, in alternate embodiments, a single reformer comprising single or multiple catalytic material compositions can be utilized for both partial oxidation and water-based reforming.

During operation, recycled water is routed from the collection chamber 128 to the mixing chamber 124 through a conduit 121, and water can be motivated from the collection chamber 128 to the mixing chamber 124 by the water pump 130. The mixing chamber 124 can receive water from the conduit 121, fuel from the fuel inlet 120 and air from the air inlet 122, and fuel is mixed with at least one of air and water in the mixing chamber 124. Fuel along with air and/or water are routed through a distribution chamber inlet 125 and through the distribution chamber into each fuel feed tube inlet 127. In an alternate embodiment, a pressure difference, for example pressure gradients resulting from water concentrations gradients throughout circulation paths of the fuel cell module100 can motivate the water through the manifold 112 without utilizing a pump, blower, or the like.

The heat recuperator 118 is provided to transfer heat between fuel cell exhaust and incoming cathode air to the insulated chamber 152. The cathode air is routed to cathode portions (depicted as 210 in FIG. 3A) of the fuel cell tubes 116 and is utilized as an electrochemical reactant for reactions at the cathode of the fuel cell tubes 116. The heat recuperator 118 includes an air inlet 182, an air outlet 180, an exhaust inlet 186, and an exhaust outlet 184.

The fuel feed tube 160 extends from the distribution chamber 126 into the insulation chamber 152. The fuel feed tube 160 is disposed in a fuel cell tube 116, wherein the fuel cell tube 16 extends from the water recycle chamber 128 into the insulated chamber 152. The insulative body 150 can comprise high-temperature, ceramic-based material for example, foam, aero-gel, mat-materials, and fibers formed from, for example, alumina, silica, and like materials.

The partial oxidation reformer 161 and the water-based reformer 162 material each comprise a metallic catalyst material such as platinum, rhodium, rubidium, nickel and the like disposed on a ceramic substrate such as an alumina or a zirconia substrate. Each partial oxidation reformer 161 and the water-based reformer 162 can be designed and located within the fuel feed tube to manage catalytic reactions and thermal distribution within the fuel stack 114. Material compositions for the partial oxidation reformer 161 and the water-based reformer 162 capable of the operating characteristics described above will be apparent to those skilled in the art.

The hydrogen separation member 164 is disposed at an end of the fuel feed tube 127 and extends out an end of the fuel feed tube 127 such that hydrogen can travel from an outer circumference hydrogen separation member 164 to an anode of the fuel cell tube 116. The hydrogen separation member 164 comprises a hydrogen separation layer including palladium or a palladium alloy. Exemplary palladium alloys can comprise palladium along with one or more of titanium, copper, silver, vanadium, and yttrium. In one embodiment, a hydrogen separation member includes a hydrogen separation layer comprising an alloy including zinc and nickel.

In an alternate embodiment, the hydrogen separation member comprises an electrically conductive matrix, a support member and/or a proton conducting matrix. In an exemplary embodiment, the electrically conductive matrix comprises primarily nickel metal. In an alternative exemplary embodiment, the electrically conductive matrix comprises a nickel-palladium matrix. The electrically conductive matrix can further comprise dopants to increase the durability of the electrically conductive matrix. The desired ratio of the electrically conductive matrix material to proton conducting carrier material for conducting hydrogen ions across the hydrogen separation member 164 can be determined based on the percolation limit, the proton conductivity of the proton conducting carrier, and the electrical conductivity of the electrically conductive matrix. The support layer comprises porous material generally compatible with proton conducting layer (including compatible with thermal expansion properties and including low reactivity) and with the operating environment of the hydrogen separation member. In one embodiment, the support layer comprises yttria stabilized zirconia. In alternate embodiment, the support material can comprise other material.

In another alternate embodiment, the hydrogen separation member 64 can include perovskite materials represented by the general formula AB₁₋ₓMₓO_{3-δ} (where A is a divalent cation such as Sr or Ba, B is Ce or Zr, M is a fixed-valent dopant such as Y, Yb, Nd, or Gd), and proton conduction within the perovskite material can be induced through the substitution of trivalent dopant ions on the B site. This substitution results in the formation of vacant oxygen sites, or in oxidizing atmospheres, the creation of electron holes. Mobile protons can then be introduced through the uptake hydrogen ions that are generated at the fuel reforming catalysts. In alternate embodiments, hydrogen can be separated utilizing membranes that function utilizing various other mechanisms. In one embodiment, hydrogen migrates between a first side and a second side of the membrane comprising a lattice structure by migrating between interstitial sites of the lattice structure.

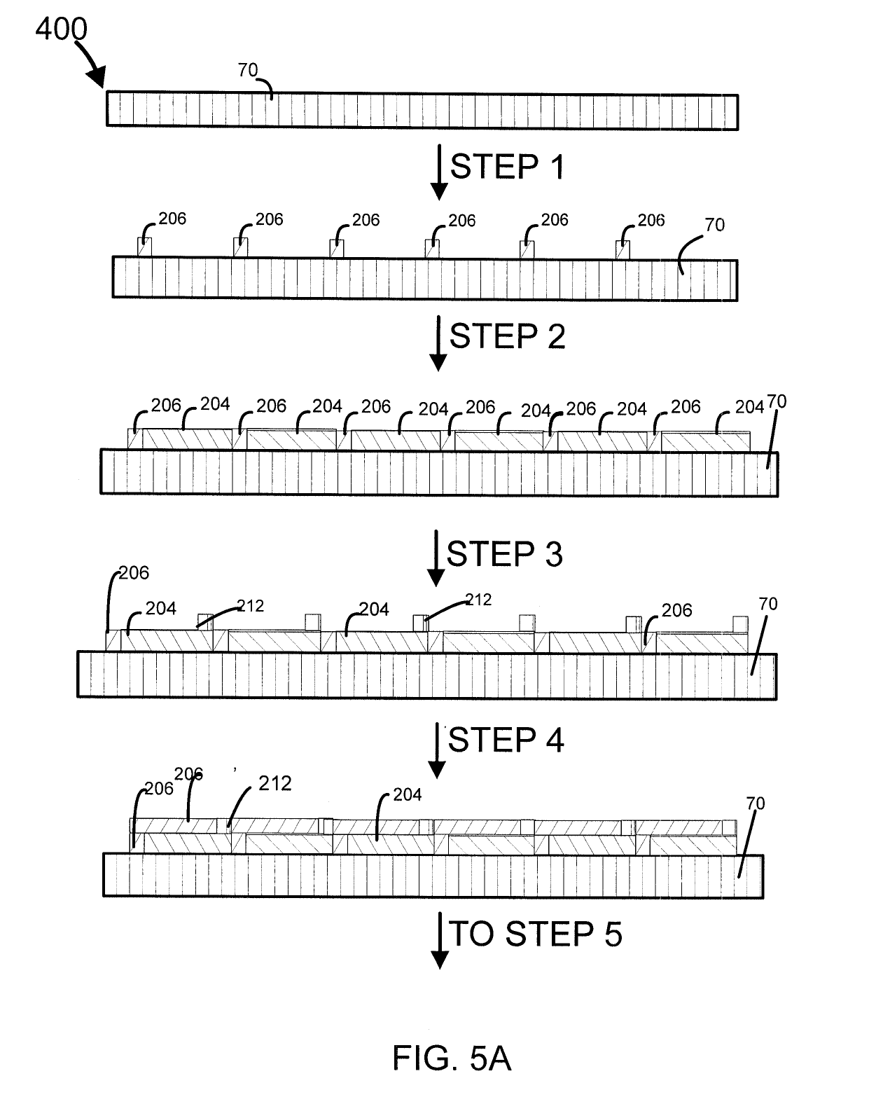

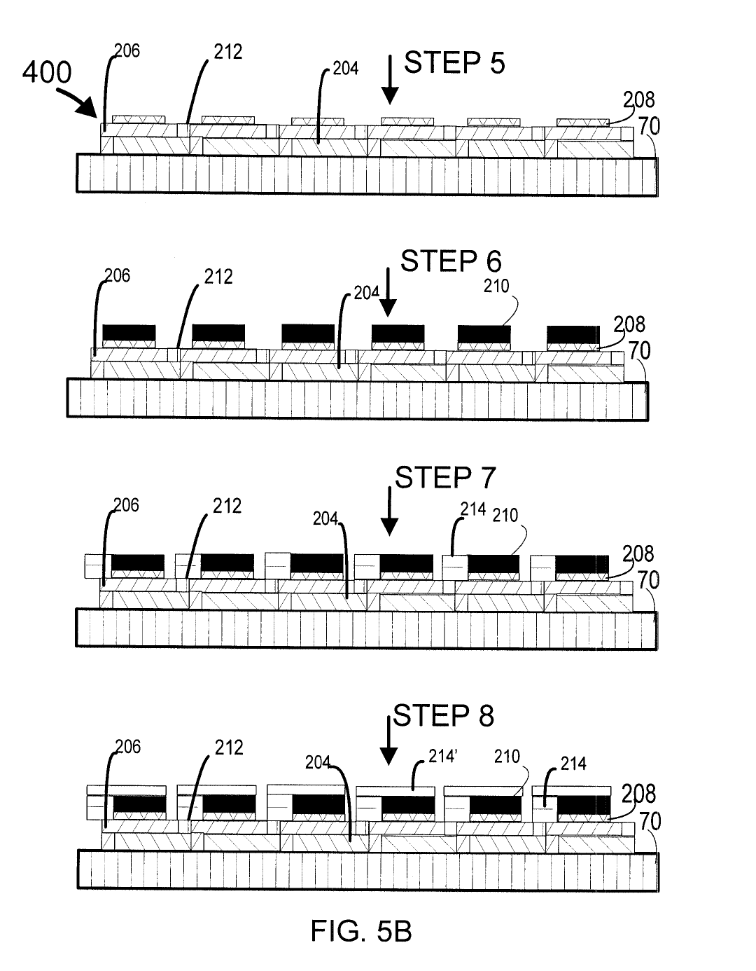

Referring to FIG. 5A-5B, the exemplary fuel cell tube 16 can be manufactured utilizing a screen printing process wherein each portion is screen-printed utilizing one or more screen printing patterns per portion, and wherein each portion is then fired individually or co-fired with other portions. The term “pattern” used in the following refers to material deposition arrangements that either individually or along with complementary patterns form the anode portion 204, electrolyte 206 and electron barrier portion 207, the intermediate portion 208, the cathode portion 210, the interconnect portion 212, and the current collector portion 214. When applied, each pattern is an ink comprising a screen printing vehicle and a constituent powder, wherein the vehicle vaporizes and the constituent powder is densified during sintering.

The support portion 70 can be manufactured as described above, and in one exemplary embodiment reforming catalysts may be disposed in the pre-formed (e.g., pre-extruded) material. In another exemplary embodiment, reforming catalyst may or may be applied through washcoating a sintered support portion 70 or by other catalyst deposition method known in the art.

At a first step, (‘STEP 1’) a first portion of the electrolyte/barrier portion 206 is screen-printed on the support portion 70. At a second step (‘STEP 2’), the anode portion 204 is screen printed on the support portion. At a third step (‘STEP 3’), the interconnect portion 212 is screen printed on the on the anode portion 204. At a fourth step (‘STEP 4’), a second portion of the electrolyte barrier portion 206 is screen-printed on the support portion 70 and then the support portion comprising the electrolyte barrier portion, the anode portion, and the interconnection portion are fired at a temperature of about 1200-1600 degrees Celsius to form a first sintered composite. At a fifth step (‘STEP 5’), the intermediate portion 208 is screen-printed on the first sintered composite and fired at a firing temperature of about 1150-1400 degrees Celsius to form a second sintered composite. At a sixth step (‘STEP 6’), the cathode portion 210 is screen-printed on the second sintered composite. At a seventh step (‘STEP 7’), a first portion of the current collector 214 is printed on the second sintered composite. At an eighth step (‘STEP 8’) a second portion of the current collection 214 is printed on the second sintered composite and the cathode portion 210, the current collector 214 and the second sintered composite are fired at a firing temperature of about 950 degrees Celsius to about 1200 degrees Celsius.

The exemplary embodiments shown in the figures and described above illustrate, but do not limit, the claimed invention. It should be understood that there is no intention to limit the invention to the specific form disclosed; rather, the invention is to cover all modifications, alternative constructions, and equivalents falling within the spirit and scope of the invention as defined in the claims. Therefore, the foregoing description should not be construed to limit the scope of the invention.

1. A solid oxide fuel cell stack comprising:
a solid oxide fuel cell tube comprising a plurality of electrochemical cells electrically connected in series, each electrochemical cell comprising an electrolyte disposed between an interior anode and an exterior cathode; and
a fuel reformer inside the fuel cell tube, wherein the fuel reformer is configured to reform a hydrocarbon fuel to a fuel cell fuel comprising hydrogen such that hydrogen is provided to the anode of electrochemical cell.

2. The solid oxide fuel cell stack of claim 1, further comprising a plurality of solid oxide fuel cell tubes.

3. The solid oxide fuel cell stack of claim 1, further comprising a tube interconnect member providing an electrical connection between a first electrical lead on an exterior of a first solid oxide fuel cell tube and a second electrical lead on an exterior of a second solid oxide fuel cell tube.

4. The solid oxide fuel cell stack of claim 3, wherein the tube interconnect member electrically connects the first solid oxide fuel cell tube and the second solid tube in series.

5. The solid oxide fuel cell stack of claim 3, wherein the tube interconnect member comprises a screen-printed pattern.

6. The solid oxide fuel cell stack of claim 5, wherein the fuel cell stack comprises an insulated body defining an insulated chamber, and wherein the tube interconnect member extends from the insulated chamber to a location outside the insulated chamber.

7. The solid oxide fuel cell of claim 1, wherein the internal reformer is disposed radially proximate to an active area of the fuel cell tube.

8. The solid oxide fuel cell tube of claim 7, wherein the internal reformer is disposed within a fuel feed tube.

9. The solid oxide fuel cell of claim 1, wherein the fuel cell tube comprises a porous support member.

10. The solid oxide fuel cell of claim 9, wherein the reformer comprises a catalyst disposed on the porous support member.

11. The solid oxide fuel cell of claim 9, wherein the reformer comprises a first catalytic member disposed within the fuel cell tube and a second catalytic member comprising catalyst disposed on the porous support member.

12. The solid oxide fuel cell of claim 1, wherein the fuel cell tube comprises a plurality of anode portions, a plurality of electrolyte portions, a plurality of cathode portions and a plurality of cell interconnect portions disposed on the support layer.

13. The solid oxide fuel cell of claim 1, wherein the internal reformer is configured to provide partial oxidation reforming.

14. The solid oxide fuel cell of claim 1, wherein the internal reformer is configured to provide autothermal reforming.

15. The solid oxide fuel cell of claim 1, wherein the internal reformer is configured to provide steam reforming.

16. The solid oxide fuel cell stack of claim 1, wherein internal reformer is disposed within the fuel cell tube such that unreformed fuel is substantially prevented from contacting anode portions of the fuel cell tube.

17. The solid oxide fuel cell stack of claim 1, wherein the internal reformer comprises at least one of platinum, rhodium, and rubidium disposed on a ceramic substrate.

18. A solid oxide fuel cell stack comprising:
a plurality of solid oxide fuel tubes in electrical connection, each tube comprising a plurality of electrochemical cells electrically connected in series, each electrochemical cell comprising an electrolyte disposed between an interior anode and an exterior cathode; and
a plurality fuel reformers inside each of the fuel cell tubes, wherein the fuel reformer is configured to reform a hydrocarbon fuel to a fuel cell fuel comprising hydrogen such that hydrogen is provided to an anode of the solid oxide fuel tube disposed inside the solid oxide fuel cell tube.

19. A solid oxide fuel cell stack of claim 17, further comprising:
a plurality of fuel feed tubes, wherein each fuel former is disposed inside one of the fuel feed tubes.

20. The solid oxide fuel cell of claim 17, wherein the fuel cell stack further comprises a thermally insulative wall and wherein the fuel feed tubes extend from a insulative chamber defined by the thermally insulative walls to a second location outside the insulative chamber.
